(19) United States
(12) Patent Application Publication
(10) Pub. No.: US 2016/0175716 A1
(43) Pub. Date: Jun. 23, 2016

(54) ONLINE AND OFFLINE LINKED GAME SYSTEM, AND COMPUTER PROGRAM

(71) Applicant: Tae Kwan KIM, Seoul (KR)

(72) Inventor: Tae Kwan KIM, Seoul (KR)

(21) Appl. No.: 14/772,753

(22) PCT Filed: Aug. 14, 2014
(86) PCT No.: PCT/KR2014/007602

§ 371 Date: Sep. 3, 2015

(30) Foreign Application Priority Data
Aug. 16, 2013 (KR) 10-2013-0097035

(51) Int. Cl. A63F 13/655; A63F 13/35; A63F 13/537; A63F 13/213

(52) U.S. Cl. CPC A63F 13/655; A63F 13/213; A63F 13/35; A63F 13/537

(57) ABSTRACT

An online and offline linked game system is disclosed. An online and offline linked game system according to an embodiment of the present invention comprises: a determination unit for determining whether a mission has been completed on the basis of code data acquired at a mission point; and a management unit for managing data for a set reward issued when the mission is determined to have been completed by the determination unit.

This application claims priority to and is a national stage application under 35 U.S.C. 371 of PCT App. No. PCT/KR2014/007602 to Kim, filed on Aug. 14, 2014 and entitled “Online and Offline Linked Game System, and Computer Program,” which claims priority to Korean App. No. 10-2013-0097035, filed on Aug. 16, 2013, both of which are fully incorporated by reference herein in their entirety.

### BACKGROUND OF THE INVENTION

1. Field of the Invention

The present invention relates to an online and offline linked game system and a computer program, and more particularly, to an online and offline linked game system and a program which are implemented in an online and offline linkage type to perform a predetermined mission in a specific region.

2. Background Art

Most games that use devices, such as computers, are two-dimensional games or three-dimensional games, and are processed by game programs installed in game machines, PCs, or mobile devices.

In conventional games, the user can enjoy the games displayed through game images, but it is difficult for the user to change the game content.

Although, the difficulty level of the game and the game content vary with stages in order to draw user's attention, the overall game content cannot depart from the standard pattern because the game content of each stage is standardized.

Recently, the Massively Multiplayer Online Role-Playing Game (MMORPG), which is a type of game to provide various pieces of content with a high degree of freedom through the interaction between a plurality of users within a specific region, has become popular.

Conventional online games arouse user's interest and immerse the user in the games, whereas ill effects due to the online game addiction is significantly increasing as well.

In particular, playing the games for a long time using the computer or the game machine may bring about various side effects, such as obesity, blood circulation disorders, amblyopia, or cardiac infarction due to lack of exercise, and may interfere with the study of the students. Thus, in reality, online games are perceived negatively by parents or guardians.

Therefore, a method for utilizing a game platform of the online game, which makes the user highly immersed in the game, as a constructive form is required.

### SUMMARY OF THE INVENTION

### Technical Objectives

In order to address the problem above, embodiments of the present invention are made to provide a game system and a program by which the online game are implemented as the offline game that involves outdoor activities while the user plays the game.

In addition, embodiments of the present invention provide a game system in the form of the MMORPG, which is implemented in the offline type in order to allow a plurality of participants to compete or cooperate with each other to thereby accomplish a predetermined mission on the basis of a specific region, and a program thereof.

Furthermore, embodiments of the present invention provide a game system and a program, which allow the user to tour a specific region in the form of a game by sharing the information on the cultural assets or landmarks in the specific region through the combination with the regional information.

Technical objectives of the present invention are not limited to the statements above, and other technical objectives not mentioned above will be understood clearly by those skilled in the art on the basis of the following description.

### Technical Solution

In accordance with one embodiment of the present invention, an online and offline linked game system may include: a determination unit that determines whether or not the mission has been completed on the basis of the similarity between code data, which is a photographed image of an object located in a mission point, and a reference image; and a management unit that manages predetermined reward data that is issued when the determination unit determines that the mission has been completed.

The code data may be a photographed image of an object located in the mission point.

The photographed image may be the data made by photographing the object at a specific position or at a specific angle, and the determination unit may compare the photographed image with a pre-stored reference image in order to thereby determine whether or not the mission has been completed.

The photographed image may be created by a camera unit of a client device, and the camera unit may provide a photographing guidance line corresponding to a portion of the appearance of the object when photographing the object.

The determination unit may determine whether or not the mission has been completed by considering the location information of the client device as well.

The reward data may include battle cards available to be collected, and a plurality of users may play person-versus-person (PvP) games through the battle cards.

A plurality of mission points may exist at different geographical locations in a predetermined region.

The system may further include a ranking unit that determines rankings of a plurality of users in consideration of the number of missions that have been completed and the lead time.

The system may further include an auxiliary unit that manages hint information on the code data, and the hint information may be provided to a user related to the corresponding user.

In the case where the client device of the first user is located in the first region where the first mission point exists, and the client device of the second user is located in the second region that is spaced from the first region, the information on the mission point, which is received from the client device of the second user, may be transmitted to the client device of the first user.

In accordance with another embodiment of the present invention, a computer program may perform the functions of: determining whether or not the mission has been completed on the basis of the similarity between code data, which is a photographed image of an object located in a mission point, and a reference image; and managing predetermined reward data that is issued when the determination unit determines that the mission has been completed.

The data may be a photographed image of an object located in the mission point.

The photographed image may be the data made by photographing the object at a specific position or at a specific angle, and the computer program may perform the function of comparing the photographed image with a pre-stored reference image to thereby determine whether or not the mission has been completed.

The program may further perform the function of determining whether or not the mission has been completed by considering the location information of the client device as well.

The reward data may include battle cards available to be collected, and a plurality of users may play person-versus-person (PvP) games through the battle cards.

A plurality of mission points may exist at different geographical locations in a predetermined region.

The program may further perform the function of determining the rankings of a plurality of users in consideration of the number of missions that have been completed along with the lead time.

The program may further perform the function of managing hint information on the code data, wherein the hint information may be provided to a user related to the corresponding user.

The program may further perform the function of, in the case where the client device of the first user is located in the first region where the first mission point exists, and the client device of the second user is located in the second region that is spaced from the first region, transmitting the information on the mission point, which is received from the client device of the second user, to the client device of the first user.

### Advantageous Effects

As described above, embodiments of the present invention can provide an offline game and a program, which allow a plurality of participants to accomplish a predetermined mission in a specific region by adopting a play form of an online game.

In addition, embodiments of the present invention can provide a game system and a program, in which secret code data is obtained from a specific mission point hidden in each region, and the secret code data is processed by a program to thereby quickly determine whether or not the mission has been completed.

Furthermore, embodiments of the present invention can provide a game system and a program, in which reward data is issued upon the completion of the mission, and the users can play an additional competitive game using the reward data.

In addition, embodiments of the present invention can provide a game system and a program, which can provide educational information to the users such that the users may be immersed therein in association with tour packages for the corresponding region.

### BRIEF DESCRIPTION OF THE DRAWINGS

FIG. 1 is a block diagram of an online and offline linked game system, according to an embodiment of the present invention;

FIGS. 2 to 4 illustrate an example of a procedure of playing a game by a user, used in conjunction with the system of FIG. 1;

FIGS. 5 to 8 illustrate an example of a method for obtaining a mission point and code data, which are used in conjunction with the system of FIG. 1;

FIG. 9 illustrates another example of a procedure of playing a game by a user, used in conjunction with the system of FIG. 1;

FIG. 10 is a block diagram of an online and offline linked game system, according to another embodiment of the present invention; and

FIG. 11 illustrates an example of a computer installed with a computer program, according to an embodiment of the present invention.

### MODE FOR CARRYING OUT THE INVENTION

Hereinafter, embodiments of the present invention will be described in detail with reference to the accompanying drawings. The advantages and features of embodiments of the present invention and methods of achieving the same will be apparent by referring to embodiments of the present invention as described below in detail in conjunction with the accompanying drawings. However, the present invention is not limited to the embodiments set forth below, but may be implemented in various different forms. The following embodiments are provided only to inform those skilled in the art of the scope of the present disclosure, and the present disclosure is not to be limited by the examples presented herein, but is envisioned as encompassing the scope described in the appended claims and the full range of equivalents of the appended claims. Throughout the specification, the same or like reference numerals designate the same or like elements.

Unless defined otherwise, all terms as used herein (including technical terms and scientific terms) have the same meaning as commonly understood by a person of ordinary skill in the art to which the present invention pertains. Such terms as those defined in a generally used dictionary are not to be interpreted to have ideal or excessive meanings unless clearly defined in the present disclosure.

The terms as used herein are merely for the purpose of describing embodiments and are not intended to limit the present invention. As used herein, singular forms are intended to include plural forms unless the context clearly indicates otherwise. The terms “comprises” and/or “comprising” as used herein refer to the existence of a disclosed element, and do not exclude the existence of or a possibility of addition of one or more other elements.

Hereinafter, an online and offline linked game system, according to an embodiment of the present invention, will be described with reference to the accompanying drawings.

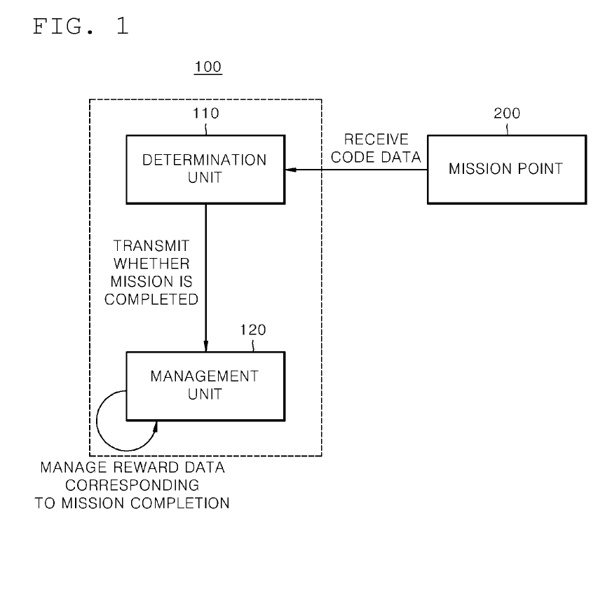

FIG. 1 is a block diagram of an online and offline linked game system, according to an embodiment of the present invention. The online and offline linked game system 100, according to this embodiment of the present invention, may include a determination unit 110 and a management unit 120.

More specifically, the present game system 100 may include the determination unit 110 that determines whether or not the mission has been completed on the basis of code data acquired from a mission point 200, and the management unit 120 that manages predetermined reward data issued when it is determined that the mission has been completed.

In the game system 100, the user, in the offline world, may access the mission point 200 located in a specific region to obtain predetermined code data, and the determination unit 110 may read the code data to thereby determine whether or not the mission has been completed. In addition, the game system 100 may provide an environment in which a plurality of users freely explore the predetermined region and cooperate or compete with each other.

In addition, if it is determined that the mission has been completed, the reward data may be issued to the corresponding user, and the users may be differentiated from each other in conjunction with a level-up system or a ranking system in order to motivate the users.

The determination unit 110 receives the code data, and reads the code data to determine whether or not the code data corresponds to the mission. The code data may be a photographed image of an object that exists in the mission point 200, but is not limited thereto. The code data may be configured in various forms, such as a code number, a bar code, a two-dimensional QR code, preset text, numbers, or symbols, which are recorded in a specific position of the mission point 200. The code data may be input through a mobile device of the participating user or an input device, such as a kiosk, that is provided in the predetermined region where the mission is to be performed, to be thereby transferred to the determination unit 110.

The determination unit 110 may be provided in the mobile device held by the user or the input device, but it is not limited thereto, and the determination unit 110 may be provided in a server that transmits/receives data to/from the mobile device or the input device.

The determination unit 110 may be configured in the form of a mobile application, and may receive the code data through various input devices.

The determination unit 110 may compare predetermined result data with the input code data, and if the similarity between the code data and the result data satisfies a predetermined range, may determine that the mission has been completed. At this time, the determination unit 110 may determine the completion of the mission by additionally considering the location information on a client device held by the participating user. For example, the determination unit 110 may determine whether or not the code data is input from a specific location to thereby determine the completion of the mission or create a mission completion score. For example, if the code data is a photographed image of an object located in the mission point 200, the determination unit 110 may determine the completion of the mission or create the mission completion score by considering the similarity of the corresponding object according to a photographing angle and the pre-collected location information on the corresponding object in total.

The management unit 120 may receive a signal stating whether or not the mission has been completed from the determination unit 110, and may issue and manage the reward data on the basis of the same.

The reward data may include all of the tangible and intangible rewards, such as scores, cyber money, points, experience points, coupons, or the like, which are issued to the user in accordance with the completion of the mission. The reward data may include battle cards available to be collected, and a plurality of users may play person-versus-person (PvP) games through the battle cards.

The mission point 200 refers to physical structures located in the predetermined region, and the users who participate in the mission may find the mission point 200 in the course of exploring the predetermined region.

A plurality of mission points 200 may exist at different geographical locations in the predetermined region. The mission point 200 may refer to cultural properties, landmarks, or historic sites in a specific region, but the mission point 200 is not limited thereto, and may refer to artificial structures, sculptures, or buildings.

The code data is disposed at a specific position inside or outside the mission point 200. The code data may be disposed at a position that is hard to be identified from the outside, but it is not limited thereto.

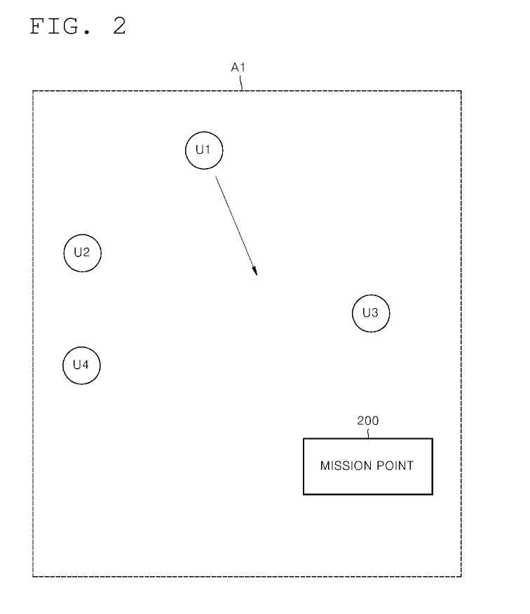

Referring to FIGS. 2 to 4, an example of a procedure of playing a game by a user, constituting the system of FIG. 1 is illustrated.

As shown in FIG. 2, a plurality of users U1, U2, U3, and U4 may proceed with the mission in a specific region Al, and each user may explore the mission point 200 in order to obtain the code data of the mission point 200. A variety of other structures may be disposed in the specific region Al in order for the mission point 200 not to be easily found by the users.

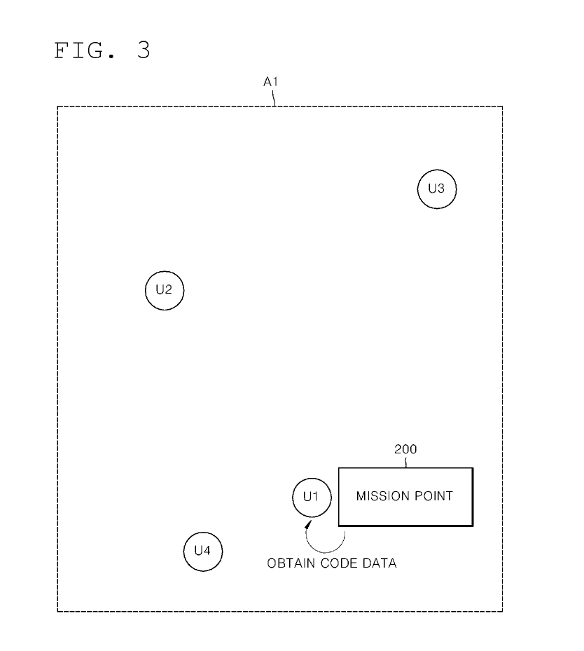

As shown in FIG. 3, the first user U1 may find the mission point 200, based on his/her own exploration, collaboration with other users, a hint provided by a guide user, or basic information on the mission point while exploring the same. When the first user U1 finds the mission point 200, the code data hidden in the mission point 200 may be obtained.

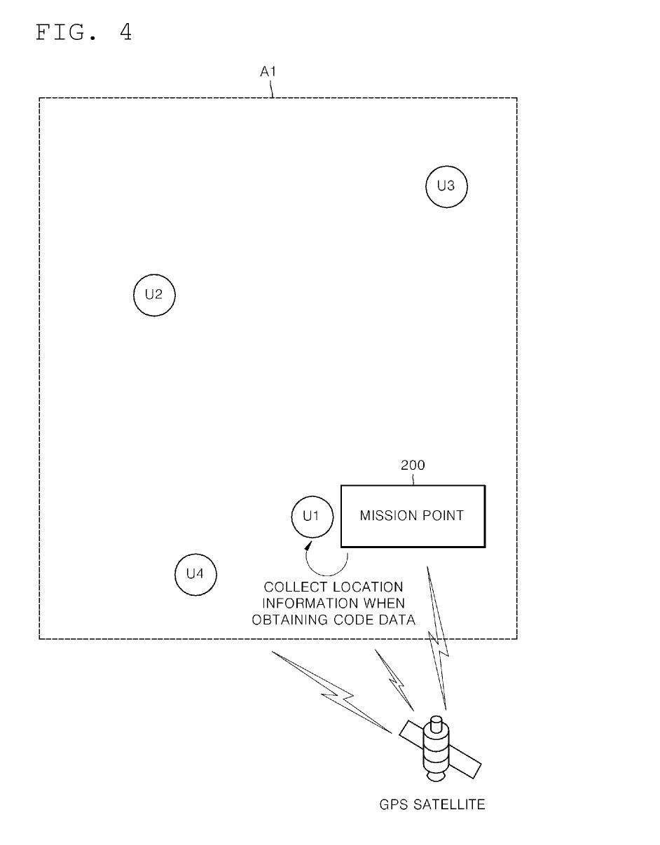

Referring to FIG. 4, in this case, as described above, the first user U1 may collect the information on the location, where the code data is obtained, through a location information collection module, such as a GPS, when obtaining the code data, and the determination unit 110 may determine whether or not the mission has been completed on the basis of the same.

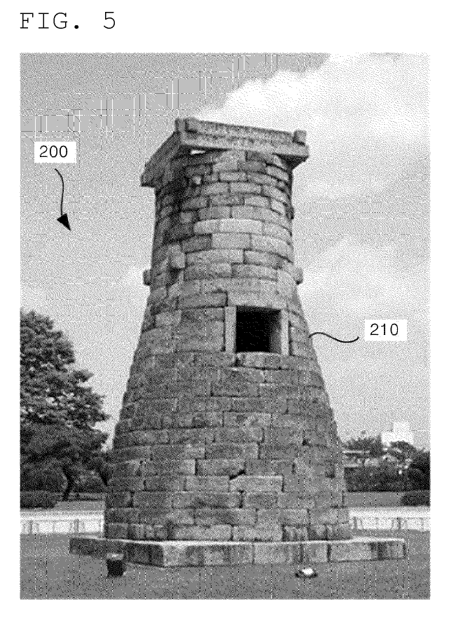

FIGS. 5 to 8 illustrate an example of a method for obtaining the mission point and the code data, which are included in the system of FIG. 1.

Referring to FIG. 5, as described above, the mission point 200 may be a specific structure, or may be a cultural property or a historic site such as Cheomseongdae as shown in the drawing.

Hereinafter, the description will be made on the assumption that the code data is an image created by photographing an object 210 located in the mission point 200. The user participating in the mission may explore the specific region to find the mission point 200 in which the code data is hidden.

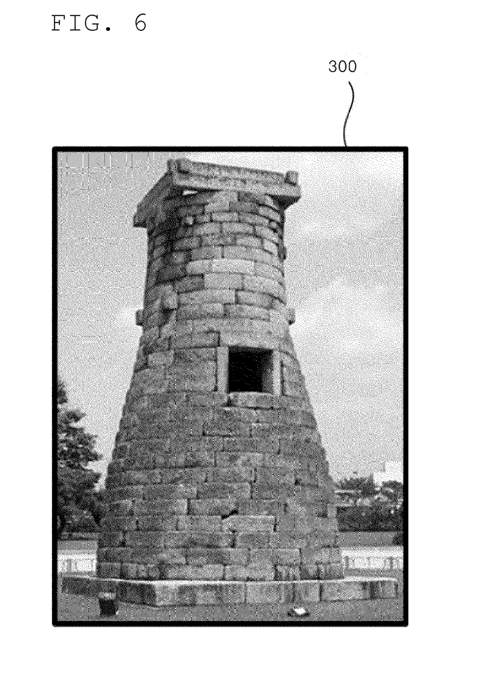

As shown in FIG. 6, when the user finds the mission point 200, a photographed image 300 of the object 210, that is, the code data that exists in the mission point 200, may be obtained. The photographed image 300 may be the data made by photographing the object 210 at a specific location or at a specific angle. That is, the guidance for photographing the object at a predetermined location or at a predetermined angle may be provided in order for the determination unit 110 to accurately determine whether or not the mission has been completed on the basis of the photographed image 300.

Based on the photographed image 300 obtained as described above, the determination unit 110 may compare the photographed image 300 with a pre-stored reference image in order to thereby determine whether or not the mission has been completed. In this process, the determination unit 110 may determine whether or not the mission has been completed by considering the location information of the client device as well. That is, the determination unit 110 may obtain the location information of Cheomseongdae as the object 210 in advance in order to build a database, and may read the location data included in the tag information of the photographed image 300 to thereby determine whether or not the photographed image 300 has been taken at the actual location of Cheomseongdae.

The determination unit 110 may compare the photographed image 300 of the object 210 with the reference image, and may differentially decide points for the completion of the mission according to the similarity on the basis of the same. Accordingly, the determination unit 110 may give the users the reward data that is different according to the success of the mission.

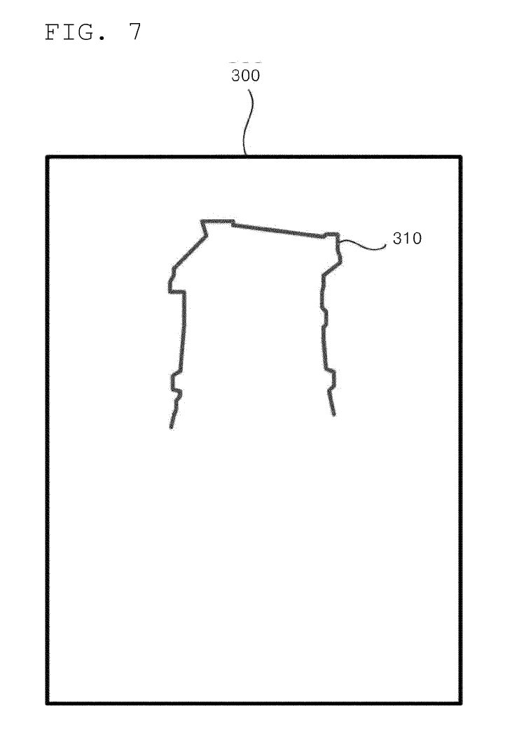

Referring to FIG. 7, the photographed image 300 may be created by a camera unit of the client device, and the camera unit may provide a photographing guidance line 310 corresponding to a portion of the appearance of the object 210 when photographing the same.

That is, when the user who has found the mission point 200 photographs the object 210, the camera unit may provide the photographing guidance line 310, as shown in the drawing, in order to provide an outline of the appearance of the object 210 and help the user in recognizing the photographing position and angle.

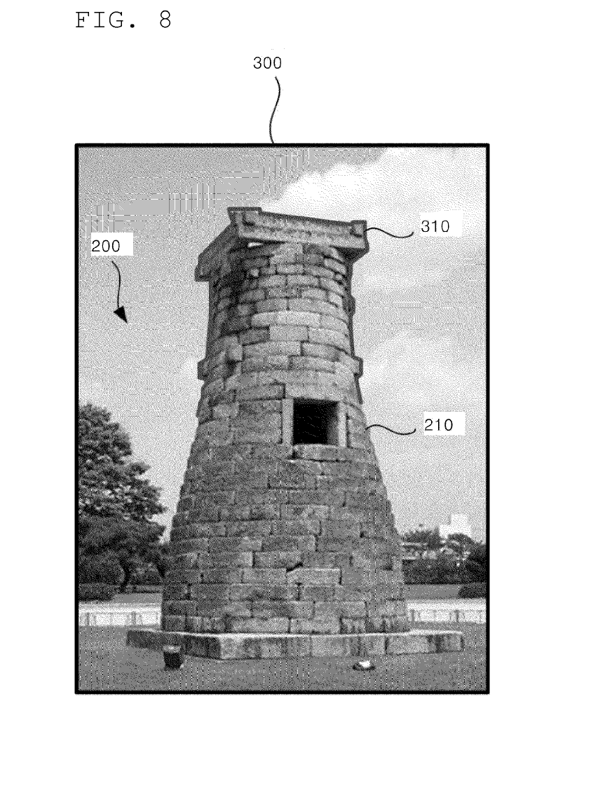

Therefore, the user may choose the photographing position and angle such that the photographing guidance line 310 matches the object 210, as shown in FIG. 8.

As set forth above, the determination unit 110 may quickly and accurately determine whether or not the mission has been completed, based on the photographed image 300 and/or the location information of photographed image 300.

In some other embodiments, the determination unit 110 may determine whether or not the mission has been completed and the mission completion score by considering the similarity between the photographed image 300 and a reference image as well. For example, in the case where the similarity between the photographed image 300 taken by the first user and the reference image is 90% and the similarity between the photographed image 300 taken by the second user and the reference image is 70%, provided that the critical value for the similarity is 80%, the determination unit 110 may determine that the first user has completed the mission, and the first user may be given the mission completion score corresponding to the similarity of 90% in the relative ratio to the similarity of 100%. On the other hand, the determination unit 110 may determine that the second user failed to complete the mission, and the second user may try to photograph the object 210 of the mission point 200 again.

In addition, in some other embodiments, the determination unit 110 may determine whether or not the mission has been completed and the mission completion score, by considering time information as well. For example, if the similarity of the photographed image 300 of the first user is 90% and the mission thereof has taken 20 minutes to be completed from the beginning, and if the similarity of the photographed image 300 of the second user is 80% and the mission thereof has taken 5 minutes to be completed from the beginning, the determination unit 110 may give a weight value to the similarity of the photographed image 300 and the mission lead time to thereby determine whether or not the mission has been completed along with the mission completion score.

In some other embodiments, the determination unit 110 may determine whether or not the mission has been completed and the mission completion score, by considering the location information as well. For example, even though the similarity of the photographed image 300 of the first user is greater than the reference similarity, if the photographing location of the photographed image 300 is out of the allowable error range of the location of the object 210, the determination unit 110 may determine that the corresponding photographed image 300 is incorrect data and the mission has not been completed.

As described above, the playing of the game and the completion of the mission by the user may be determined through a combination of various methods, and the repeated performance of different missions according to the same may create the rankings for the mission completion. In addition, the reward data provided by the management unit 120 may be accumulated, and the reward data may be utilized as the battle cards in order to thereby provide a new game-in-game between the users.

Furthermore, although the code data has been described to be the photographed image 300 in the present embodiment, it is not limited thereto, and may be codes of a number, text, or an image, which are provided at a specific position of the mission point 200. The code data may be directly input through the client device as well as the method of photographing the images.

In some other embodiments, a plurality of mission points 200 may exists at different geographical locations with each other in the specific region.

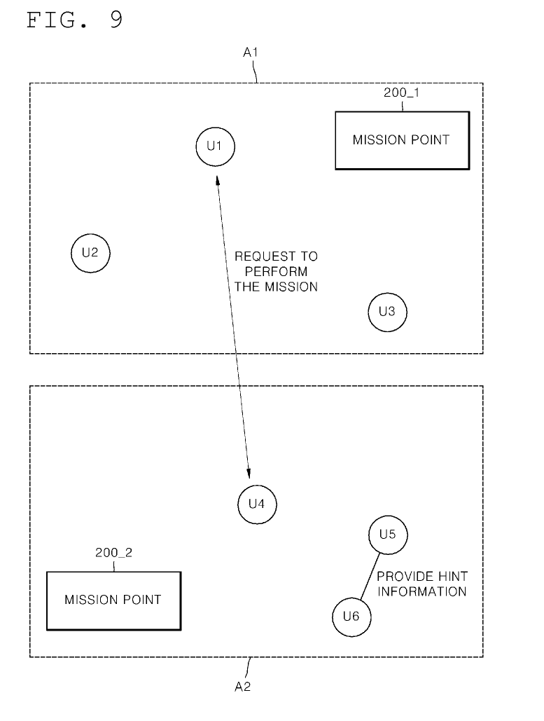

FIG. 9 illustrates another example of a procedure of playing a game by a user, constituting the system of FIG. 1.

In the illustrated embodiment, the client device of the first user U1 may be located in the first region Al where the first mission point 200_1 exists, and the client device of the second user U4 may be located in the second region A2 that is spaced from the first region Al.

At this time, the online and offline linked game system, according to the embodiment of the present invention, may transmit the information on the mission point 200_1, which is received from the client device of the second user U4, to the client device of the first user U1.

In addition, when the client device of the second user U4 makes a request to the client device of the first user U1 for performing the mission on the behalf of the client device of the second user U4, the online and offline linked game system, according to the embodiment of the present invention, may transmit the request of the client device of the second user U4 to the client device of the first user U1.

That is, the client devices of a plurality of users who perform the mission may exchange the information with each other through the online and offline linked game system, according to the embodiment of the present invention, or may share the information in collaboration with the client devices of the users who are located in another region.

In addition, the hint information may be provided between the client devices of specific user U5 and U6 through the online and offline linked game system, according to the embodiment of the present invention.

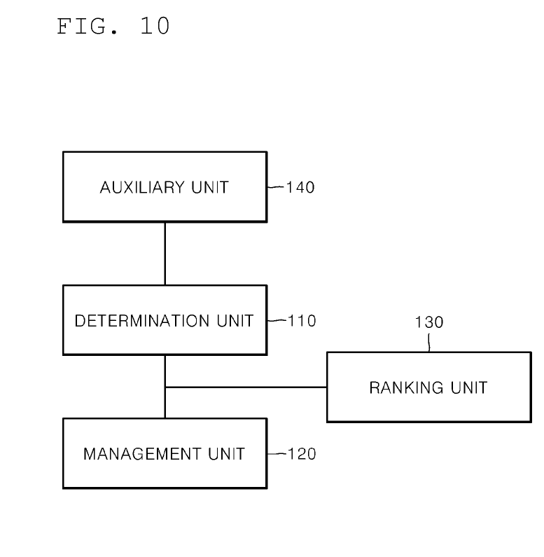

FIG. 10 is a block diagram of an online and offline linked game system, according to another embodiment of the present invention.

The online and offline linked game system, according to the embodiment of the present invention, may include the determination unit 110 and the management unit 120, and may further include a ranking unit 130 and an auxiliary unit 140.

The ranking unit 130 may determine the rankings of the plurality of users in consideration of the number of missions that have been completed, as well the lead times. As described above, in order to arouse users' interest through the competition between the users, the ranking unit 130 may measure the rankings of a plurality of users who are separated according to various references, such as all of the users, or the users in a specific region, and may provide the same to each of the users. The more missions the user completes quickly and accurately, the higher ranking the user may be.

The auxiliary unit 140 may manage the hint information on the code data, and the hint information may be provided to a user related to the corresponding user. That is, the hint information may be selectively provided to the normal users, so the hint information may be selectively provided to a specific guide user so that the normal user can be provided with the hint information from the guide user to thereby facilitate the game. The hint information may be provided to the user through the client device held by the user or the device disposed in the region where the mission is performed. For example, if the participating user is a minor, and the auxiliary unit corresponds to a guardian, the hint information may be provided to the guardian and the minor may easily perform the mission by the aid of the guardian.

The online and offline linked game system, according to the embodiment of the present invention, may be implemented as a computer program.

The computer program, according to the embodiment of the present invention, may perform the functions of: determining whether or not the mission has been completed on the basis of the similarity between code data, which is a photographed image of an object located in a mission point, and a reference image; and managing predetermined reward data that is issued when the determination unit determines that the mission has been completed.

At this time, the data may be a photographed image of an object located in the mission point.

The photographed image may be the data made by photographing the object at a specific position or at a specific angle, and the computer program, according to the embodiment of the present invention, may perform the function of comparing the photographed image with a pre-stored reference image to thereby determine whether or not the mission has been completed.

The computer program, according to the embodiment of the present invention, may further perform the function of determining whether or not the mission has been completed by considering the location information of the client device as well.

At this time, the reward data may include battle cards available to be collected, and a plurality of users may play person-versus-person (PvP) games through the battle cards.

A plurality of mission points may exist at different geographical locations in a predetermined region.

The computer program, according to the embodiment of the present invention, may further perform the function of determining rankings of a plurality of users in consideration of the number of missions that have been completed along with the lead time.

The computer program, according to the embodiment of the present invention, may further perform the function of managing hint information on the code data, wherein the hint information may be provided to a user related to the corresponding user.

The computer program may further perform the function of, in the case where the client device of the first user is located in the first region where the first mission point exists, and the client device of the second user is located in the second region that is spaced from the first region, transmitting the information on the mission point, which is received from the client device of the second user, to the client device of the first user.

The various functions above have already been described above with reference to FIGS. 1 to 10, so the detailed description thereof will be omitted.

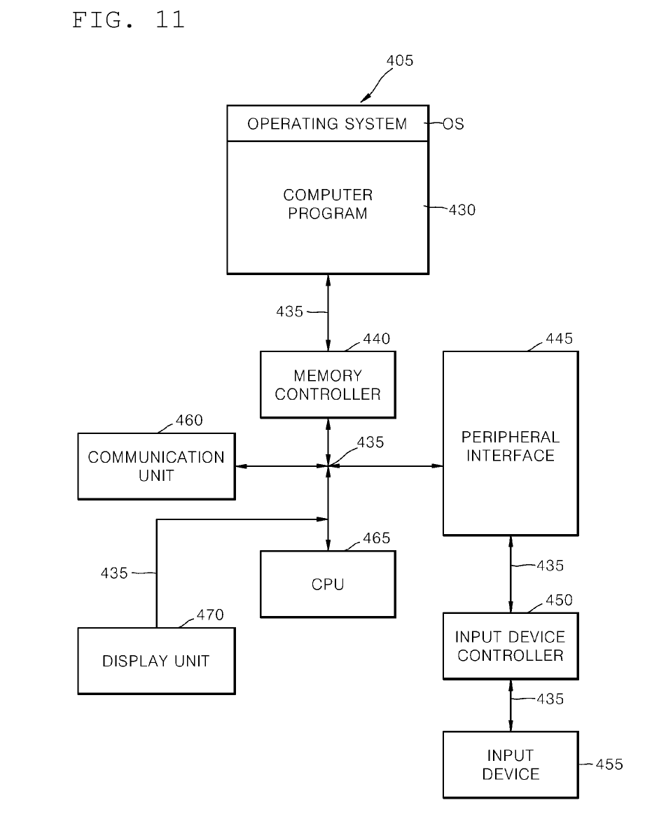

FIG. 11 illustrates an example of a computer installed with a computer program, according to an embodiment of the present invention.

The computer program, according to an embodiment of the present invention, may be installed in a recording medium 705, which can be read by computers. The computers may be a variety of devices, such as smart phones, laptop computers, PCs, tablets, or servers, but may not be limited thereto.

The elements of the computer may communicate with each other through one or more communication buses or signal lines 435. Such a computer may exclude some of the elements shown in FIG. 11, or may include additional elements. The computer shown in FIG. 11 may be implemented by hardware, software, or a combination thereof.

The recording medium 705 may store software components, and the software components may include an operating system (OS) and a computer program according to the embodiment of the present invention.

The recording medium 705 may be CDs, DVDs, USBs, hard disks, RAMs, flash memories, or may be a remote storage unit that can be connected through a network.

The operating system (OS) may include various software components and drivers in order to control the general system tasks. In addition, the operating system (OS) may transform the data, such the search result, the visualization data of the search result, analysis data, or additional analysis data, to data packets in order to transmit the same through the network.

The operating system (OS) may be Linux, UNIX, the Windows-based server OS, the iOS, the Android OS, or the Windows-based PC OS, but is not limited thereto.

The CPU 465 may load and execute software components, such as the operating system (OS) and the computer program 430.

The memory controller 440 may control the connection of other elements, such as the CPU 465 or a peripheral interface 445, to the recording medium 405.

A communication unit 460 may communicate with other computing devices that are connected with or access the network, such as the Internet or a mobile communication network, but is not limited thereto.

The peripheral interface 445 may connect an input device 455, such as a mouse, a keyboard or a touch screen, to the CPU 465 and the recording medium 705.

An input device controller 450 may receive electrical signals received from the input device 455, and may convert the same into signals that conform to the standard of the communication buses or the signal lines 435.

A display unit 470 may display the operating status of the computer program, according to the embodiment of the present invention.

While the embodiment of the present disclosure has been described with reference to the accompanying drawings, it will be understood by those skilled in the art that the present disclosure may be varied and modified without departing from the technical spirit and the essential feature of the present disclosure. Accordingly, it should be understood that the embodiments described above are merely exemplary and are not limitative.

1. An online and offline linked game system comprising:
a determination unit configured to determine whether or not a mission has been completed on the basis of the similarity between code data and a reference image, said code data comprising a photographed image of an object located at a mission point; and
a management unit configured to manage predetermined reward data that is issued when the determination unit determines that the mission has been completed.

2. The online and offline linked game system as claimed in claim 1, wherein the code data is a photographed image of an object located at the mission point.

3. The online and offline linked game system as claimed in claim 2, wherein the photographed image comprises the data made by photographing the object at a specific position or at a specific angle, and the determination unit is configured to compare the photographed image with a pre-stored reference image in order to thereby determine whether or not the mission has been completed.

4. The online and offline linked game system as claimed in claim 2, wherein the photographed image is created by a camera unit of a client device, and the camera unit is configured to provides a photographing guidance line corresponding to a portion of the appearance of the object when photographing the object.

5. The online and offline linked game system as claimed in claim 1, wherein the determination unit is configured to determines whether or not the mission has been completed by also considering the location information of a client device.

6. The online and offline linked game system as claimed in claim 1, wherein the reward data includes battle cards available to be collected, and wherein a plurality of users can play person-versus-person (PvP) games through the battle cards.

7. The online and offline linked game system as claimed in claim 1, wherein a plurality of mission points exist at different geographical locations in a predetermined region.

8. The online and offline linked game system as claimed in claim 1, further comprising a ranking unit configured to determines-rankings of a plurality of users in consideration of lead times and the number of missions that have been completed.

9. The online and offline linked game system as claimed in claim 1, further comprising an auxiliary unit configured to manage hint information on the code data, wherein the hint information can be provided to a first user related to a corresponding user.

10. The online and offline linked game system as claimed in claim 1, wherein, in the case where a client device of a first user is located in a first region where the mission point exists, and a client device of a second user is located in a second region that is spaced from the first region, information on the mission point, which is configured to be received from the client device of the second user, is configured to be transmitted to the client device of the first user.

11. A computer program for performing the functions of:
determining whether or not a mission has been completed on the basis of the similarity between code data, and a reference image, said code data comprising a photographed image of an object located at a mission point; and
managing predetermined reward data that is issued when it is determined that the mission has been completed.

12. The computer program as claimed in claim 11, wherein the data is a photographed image of an object located at the mission point.

13. The computer program as claimed in claim 12, wherein the photographed image is the data made by photographing the object at a specific position or at a specific angle, and the computer program further performing the function of comparing the photographed image with a pre-stored reference image to thereby determine whether or not the mission has been completed.

14. The computer program as claimed in claim 11, further performing the function of determining whether or not the mission has been completed by also considering the location information of a client device.

15. The computer program as claimed in claim 11, wherein the reward data includes battle cards available to be collected, and a plurality of users can play person-versus-person (PvP) games through the battle cards.

16. The computer program as claimed in claim 11, wherein a plurality of mission points exist at different geographical locations in a predetermined region.

17. The computer program as claimed in claim 11, further performing the function of determining rankings of a plurality of users in consideration of lead times and the number of missions that have been completed.

18. The computer program as claimed in claim 11, further performing the function of managing hint information on the code data, wherein the hint information is provided to a first user related to a corresponding user.

19. The computer program as claimed in claim 11, further performing the function of, in the case where a client device of a first user is located in a first region where the mission point exists, and the client device of a second user is located in a second region that is spaced from the first region, transmitting information on the mission point, which is received from a client device of the second user, to the client device of the first user.
